(19) United States
(12) Patent Application Publication
(10) Pub. No.: US 2019/0329926 A1
(43) Pub. Date: Oct. 31, 2019

(54) Method and Device for Label Arrangement on a Crate, In Particular a Bottle Crate

(71) Applicant: Schoeller Allibert GmbH, Schwerin (DE)

(72) Inventors: Herman Gommer, Schoonebeek (NL); Klaus-Jürgen Fischer, Bad Salzuflen (DE); Carsten Malschowsky, Schwerin (DE)

(21) Appl. No.: 16/462,136

(22) PCT Filed: Oct. 25, 2017
(86) PCT No.: PCT/EP2017/077354

§ 371 Date: May 17, 2019

(30) Foreign Application Priority Data
Nov. 17, 2016 (DE) 10 2016 122 077.9

(51) Int. Cl. B65D 1/24; B29C 45/14

(52) U.S. Cl. CPC B65D 1/24; B65D 25/36; B29C 45/14008

(57) ABSTRACT

In a method for applying of IML films on crates, in particular bottle crates, a single, the entire crate circumference enclosing IML label is used, which is transferred via an insertion gripper after completion of cutting to the appropriate length in a tool for injection molding of the crate made of plastic and is inserted.

The invention relates to a method and apparatus for label application on a crate, in particular a bottle crate, according to the preambles of the independent claims directed to a method and apparatus.

In particular, the invention relates to the bottle crate field, i.e. crates, which receive a variety of beverages, such as beer, water, soft drinks and the like. Such crates are required in large quantities and the beverage manufacturer or the brewery also tries more and more to set themselves apart from its competitors by a stand-alone crate design and label configuration using the crates. Therefore, it is both a matter of the shape of the crate as well as of the labeling, that is of the attachment of appropriate identification means. Here the focus is on achieving a greatest possible advertising effect by a flawless and qualitatively prominent label arrangement on the crate at suitable locations.

Labels on the bottle crate are usually mounted in the manner of so-called IML foils on the crate, i.e. in-mold films, which are mounted on the outside of the bottle crate at suitably selected locations. Such in-mold labels are formed of plastic films and are used in single-layer and multi-layered formation especially using transparent protective films and the like. Here, these films bear usually the name and logo of the beverage manufacturer or the brewery, the brand name of the product, which is marketed via the crates, and include also corresponding optical designs and make-up important for the marketing of the beverage manufacturers or the breweries. Here, it is important to install the in-mold label (IML label) permanently on the crate in a high-quality manner so that no interference occurs with respect to the marketing effect. It must also be considered that these crates must guarantee cycle times of up to 10 years as a rule, so it is also essential that the quality effect via the label is guaranteed even over long periods of use of such crates.

The IML Technology has been known for many years and is common in the field of bottle crates in order to apply labels to the appropriate locations. In-mold labeling means that the IML film is arranged on the tool jaws or mold jaws of an injection mold tool and prior to the injection process and then the hot and therefore molten plastic is injected into the mold cavity after closing of the tool jaws to form the injection mold. This results in that the film disposed on the inside of the tool jaws or the corresponding tool components is intimately bonded via a hot-melt bond with the outside of crate fabricated by injection molding. In this way a permanent bond is ensured.

To this end it is known (EP 2 251 175 A) to use IML labels that are positioned via a specially manufactured apparatus on the inner sides of tool jaws of the injection mold tool. Therefore, the corresponding apparatus requires a label translator to which the foil-like advertising media are fed from a magazine via a first robot. The label translator to be specially formed, which receives the IML film, is transferred after arrangement on the label translator via a second robot into a label feeder which is inserted between the segments of the label translator by means of the second robot. In this way it is possible to transfer the film received on the label feeder to the corner regions of an injection molding tool so that the bottle crate formed afterwards by injection molding of plastic into the mold cavity is provided in the corner region each with a label which can be kept without any gap in the corner region. The method described therein and the apparatus described therein are complicated and cumbersome making the labeling in total expensive. Furthermore, the label application is limited to the corner areas of such crates.

Finally, it is known from DE 10 2004 009 406 A1 to form the forming jaws in injection molding tools for IML labeling in such a way that they have a flat recess for receiving the IML film. Here, the tool jaws are shaped so that the corner regions of the crate to be manufactured can be equipped in each case with a film in order to apply here also, as in the above-mentioned prior art according to EP 2 251 175 A1, the labels on the four corners. Here, it is again about an optimized application of labels in the four corners of a crate.

DE 10 2004 063 348 A1 also deals with the individualization of beverage crates by applying beverage brands, i.e. labels, in the form of printed films and the like. However, the film is applied there only after the production of the bottle crate by injection molding via a separate sealing process to the desired location of the crate. Thus, it is a comparatively expensive process which is hardly used anymore in practice or has been replaced by the common IML film which is permanently molded directly on the injected crate using injection molding automatically by hot melt composite.

DE 10 2005 013 723 B3 relates to specially shaped injection molding tools for the application of labels to beverage crates which are back-injected with the injection of the plastic into the mold cavity and thus are firmly connected to the crate. Here, the mold jaws of the injection mold tool each have associated contour jaws which may be moved between the demolding and injection position and have a closed circumferential cavity-side boundary surface, each having a receptacle for the label in the spray position. When closing the tool, the contour jaws forcibly coupled with the supporting jaws are shifted into the injection position, wherein an insert for a film is limited at a circumferential recess provided at the cavity side. After inserting the film, the back-injection takes place and thereby the composite of the label with the crate prepared by injection molding is achieved. In this technique a gap remains between the two label ends which is optically disadvantageous. Further, there may be a slipping of the label ends relative to one another so that thereby an unsightly appearance and thus a disadvantageous label assembly on the crate may be the case.

The object of the invention is to optimize the IML labeling of such crates, preferably bottle crates, in particular to avoid the limitation to corner portions of bottle crates. Here, the focus is on a simple application of the film in a mechanized flow process which allows for a varied and especially gap-free, that is to say a fully circumferential or an optically continuous circumferential appearance, mounting and arrangement of such films on beverage crates.

This object is solved according to the invention by the features included in the characterizing part of claim 1, wherein expedient embodiments of the invention are achieved by the features included in the characterizing part of the dependent claims. This applies not only to the inventive method but also to the inventive apparatus for applying such IML labels.

Here, it should also be possible within the scope of the invention to apply elaborate designed labels, such as labels with a wavy contour and the like, in flawless quality and in a simple manufacturing manner on such bottle crates.

Thus, the invention relates to a method and apparatus for applying IML labels on crates, preferably bottle crates, in which a label arrangement is achieved by a device in a tool for injection molding of the crate of plastic. Here, a tool is used having a plurality of tool jaws imaging the outer periphery of the crate which are moved from their open position for the label arrangement of the tool, in which the tool jaws are moved outwardly, into the closed position imaging the outer periphery of the crates in the tool interior. Finally, the plastic material is injected for crate production in closed position of the tool. This plastic material is molten during injection and connects thereby intimately with the IML film held in the tool.

According to the invention, a single IML label is used for application to the exterior of the crate which encloses the entire crate periphery as a label. For this purpose, the IML label is circumferentially applied, so to speak, to the tool jaws in shape of a hose.

The application is conveniently carried out by an insertion gripper which receives a hose formed from a label strip or label blank and transfers this into the tool so that the tubular IML label is applied to the tool transferred in closed position such that the plastic may then be injected for crate production.

Here, it is expedient that the contour of the insertion gripper receiving the tube for the transfer of the tube to the tool is adjustable to the outer contour of the crate which may be done conveniently at least partially by preferably circumferential expansion of the insertion gripper receiving the hose, wherein the expanded contour of the insertion gripper corresponds conveniently to the outer contour in the arrangement region of the IML label at the crate so that, when closing the injection mold, the tool jaws abut on the IML film. If a vacuum is then applied onto the tool jaws, which is advantageous, the circumferentially closed annular-like or tubular-like label is transferred to the tool, so to speak, and held there for the injection process. The transfer may also be done advantageously by using a static charge or the like.

A convenient feature of the invention is that the IML label is formed as a continuous label that is at least shaped in correspondence to the periphery of the crate so that the label may seamlessly enclose, after application to the assembly area, this outer contour of the crate produced by injection molding of the crate, i.e. as a one-label-solution.

The tube-like contoured IML label is an IML film which can be a single-layer or multi-layer conveniently provided with a protective layer and with advertising media such as by printing and the like. These films are expediently formed of plastic and are known as such in the bottle crate field so that further description is not necessary.

In the simplest case the label tube or the label ring corresponds to the outer contour of the crate in the circumferential direction because crates with even side wall areas, in particular with four side walls, are usually preferably used. Here, it is advantageous that the arrangement region of the label is slightly recessed relative to the corresponding outer surface of the side wall which is convenient for reasons of scratch protection.

It is advantageous to carry out the transfer of the IML hose to the tool by vacuum suction, because it is very simple accomplishable, for which corresponding vacuum openings may be provided in the tool jaws, forming jaws and/or label plates and/or insertion grippers. Conveniently, the mounting of the tubular-like label is also carried out at the tool by secure bonding by moving the tool jaws to the tubular film of an insertion gripper expanded, for example, for the imaging of the outer contour of the crate in which, although the tube is held under tension due to expansion, it nevertheless rests loosely on the insertion gripper so that, when returning the expansion of the insertion gripper for the exception of the crate the tubular-like film then remains statically adhering to the tool jaws.

It is advantageous that the length of the IML label for the tube formation corresponds to at least to the length of the circumference of the crate. In this case, it is expediently important to measure the exact length of the IML label at the corresponding outer contour of the crate to be manufactured, which is, of course, determined by the tool jaws driven in the closed position and the like. This ensures a gap-free label formation over the periphery since the ends of the tube lie flush in case of exact dimensioning on the periphery of the outer contour, whereby the joint of the advantageously flush adjoining label ends inside and/or outside the tube is bridged by a connecting strip which covers respectively the joint between the two label ends. This is expediently formed from the same film material as the label film. The composite is achieved here conveniently by welding or gluing. When back injection is done with hot liquid plastic melt, the gap no longer appears optically. Moreover, in such a one-piece hose-like film the flush joint area of the hose may be placed at a location over the circumference of the outer contour, where due to printing or the like, the gap is no longer optically noticeable or identifiable anyhow.

However, it is provided in a preferably advantageous manner that the IML label is cut to a length corresponding to the circumference of the outer contour, preferably in the arrangement region of the label, plus a certain projection to be dimensioned for practical reasons, but preferably in the range between 2 to 15 mm, preferably 2 to 10 mm, preferably up to 8 mm. In this case the overlapping region serves the composite of both ends of the label blank to form the circumferential tube which is conveniently achieved by welding or gluing. This dimensioning of the blank of the IML label has the advantage that ultimately no gap remains at all between the label ends. In this overlapping region a composite of the two label ends or tube ends can be achieved conveniently where a strong non-detachable connection is preferred. In that regard a gap-free circumferential tube is created so that the circumferential label can be placed on the crate in a manner that is preferably optically perfect. The composite can be achieved by an adhesive that is already provided in advance in grids of certain length on the endless label so that when precisely cutting, this adhesive is always present in the overlapping region of the two hose ends and is then activated conveniently via the preferably robotic insertion gripper during insertion, in order to produce the composite. Alternatively, the adhesive can be applied directly at the blank station to the label blank, which is equally preferred, however, and the ends of the tube can be connected therewith. However, a composite tube by welding the ends of the IML film with each other is preferably convenient. This can be done conveniently during back injection or during injection of molten plastic into the injection mold in fact automatically as a result of the injection of hot liquid plastic. Preferably suitable is a weld by means of an ultrasonic apparatus. In case of an IML lying end to end, back-injection by plastic can also be performed during injection molding preferably with a connecting strip provided in the joint area and thereby the composite of the hose. Conveniently, an adhesive already applied when printing the label film in the area of the overlap may then be activated by pressure and heat during the injection of the molten mass so that the two label ends are joined.

Within the scope of the invention, it is preferably expedient that the blank of the IML label for the tube formation is done from a roll of a wound “endless” IML film. Here, the cutting is advantageously carried out regardless of the label positioning in the tool, preferably adjacent to the label positioning station. In this way one saves a certain storage since the IML label is separated directly from an endless roll preferably close to the injection mold tool and may then be immediately transferred via the insertion gripper in the positioning direction.

Within the scope of the invention, it is also expedient that the IML film is preferably provided with optically readable markers for the purpose of detecting the length of the label blank, preferably with punching markers, preferably is printed. Thus, an exact length of the blank is ensured in each case in a simple manner.

Conveniently, the tube formation of the cut IML label is done at the blank station. Here, the tube may preferably be incrementally deposited in a magazine in tubular form and then be removed from there by the preferably robotic-like insertion gripper. Thereby, one and the same gripper can be used for insertion and removal of the tube.

Here, it is advantageous to use a receiving table which receives the label film unwound from the IML roll and also includes the cutting apparatus to perform the matching cut of the crate for the outer periphery and the arrangement in the arrangement region. Here, it is expedient to arrange an apparatus for the length detection and/or length measurement also on the receiving table. Expediently, the receiving table is arranged close to, preferably next to the injection mold tool.

Conveniently, the cut to length of the label blank from the IML roll is received either by applying a vacuum at the insertion gripper or a static charge from the insertion gripper. Here, it is advantageous that the gripper is mounted rotatably and rolls off, so to speak, the label blank lying on the receiving table and receives, therefore, the blank label circumferentially contour-compliant via the gripper. Here, the composite of the ends of the label blank to the hose can already be achieved at this point. If necessary, the insertion gripper can deposit the tube in a magazine or transfer the same directly into the open injection mold tool. In that respect a welding and/or adhesive station is provided expediently on the receiving table in order to connect the ends of the label blank captured by the gripper with each other to the circumferential tube or ring.

Furthermore, it is convenient for a precise centering of the tube on the gripper and/or at the tool jaws to attach or form suitable docking elements as in the shape of bulge-like protrusions that are engageable with the hose in its positioning position. This facilitates an exact positioning of the label tube within the tool for the injection molding process.

Conveniently, the insertion gripper for removing the injection-molded crate from the tool can be transferred into a contour enabling the disengagement of the insertion gripper, which is expediently shaped in the manner of a robot, from the label tube, and thus the retracting or withdrawal of the crate from the injection mold. Conveniently, the insertion gripper for the final contouring of the IML hose is expandable, which is mechanically caused in many ways possible. For example, the insertion gripper can be divided into different segments or jaws which can be moved laterally and/or outwardly for the purpose of mounting the hose and/or inwardly for removal of the crate so that a reduced “removal cross-section” of the gripper preferably results. Within the scope of the invention, it is also conceivable that the expansion is achieved by compressed air injection or gas injection via a circumferential hose at the insertion gripper which applies the label at the gripper either directly or by interposition from label guide members outside of the tube at the inwardly moved tool jaws in closed position. Four corner jaws are provided at the gripper that are diagonally movable inwardly and outwardly and are imaging the corner area of the label arrangement region and are having conveniently a circumferentially disposed tension strip and may reduce in cross-section or decrease in size for the purpose of removing the gripper from the tool.

Within the scope of the invention, an apparatus is advantageous for applying a single or one-piece IML film circumferentially on the bottle crate to be manufactured which has a cutting station in which an IML label blank is created. Its length is conveniently at least the length of the outer circumference of the crate in the arrangement region of the IML label preferably corresponding to the crate. In addition, a label positioning station is conveniently provided which is provided with an insertion gripper preferably in form of a robot for receiving the label tube and the transfer thereof into the open tool.

Conveniently, the blank station is formed or provided with a centering station so that the label blank tailored to the appropriate length can be brought into a tube shape adapted to the crate circumference. This is done expediently by the insertion gripper. Conveniently, the centering station may be provided with a magazine for accommodating the IML labels respectively formed to a circumferential tube. This is advantageously arranged in the vicinity, preferably adjacent to the label positioning station. In this way the hose can be removed easily and quickly from the magazine by the insertion gripper and can be introduced with a movement, so to speak, in the correct position into the tool.

Conveniently, the apparatus comprises a length measuring system for checking the exact cutting to length of the IML label for tube formation wherein the IML label can be unwound from a roll for the blank in an advantageous manner. The IML film may be disposed on a carrier so that during winding and unwinding the IML film cannot be damaged.

Conveniently, the apparatus comprises a length recognition system that operates preferably optically. This responds appropriately, for example, for the detection of punching markers or like positioning elements on the IML film. In the context of exact positioning it is also appropriate that the apparatus has docking elements, such as bulge-like projections, knobs and the like, in order to bring about an exact positioning of the tube. Here, the docking elements can be provided at the insertion gripper and/or the tool jaws. Of course, the configuration of the docking elements is arbitrary insofar as they are suitable, so that recesses are also possible here, preferably when docking elements are provided complementarily at both the tool jaws and the insertion gripper.

Conveniently, the insertion gripper is provided with movable construction elements preferably in form of gripper jaws that image in the extended position the outer contour of the crate in the arrangement region of the labels and in the retracted position allow for a removal of the insertion gripper from the mold for the injection molding process due to a reduced cross-section or a reduction of the circumference. Conveniently, the gripper is provided preferably with four diagonally movable corner jaws. These can cooperate, for example, with a circumferential tension band for contouring that can tension the label tube and apply the same to the tool.

As insertion gripper other mechanisms, especially those with spreaders, may also be used. For example, grippers would also be possible which are provided with inflatable tube elements or, for example, with a circumferential inflatable tube so that a desired expansion of the insertion gripper with the tubular film received may be done in adaptation to the desired outer contour may be made in a simple manner. This also allows for a simple reduction of the cross-section of the insertion gripper to remove the same before the injection process after the transfer of the tubular film to the tool jaw from the injection mold tool.

In the context of the method and apparatus, it is convenient to use a tool having tool jaws in which each tool jaw has a mold jaw and a label plate for the uptake or application of the label tube in the closed position. Here, the label plates map the outer contour of the arrangement region for the tube label in closed position. In this case the label plates may be moved relative to the mold jaws.

Subsequently, the invention will be described based on the drawings in a purely schematic manner. Therein shows:

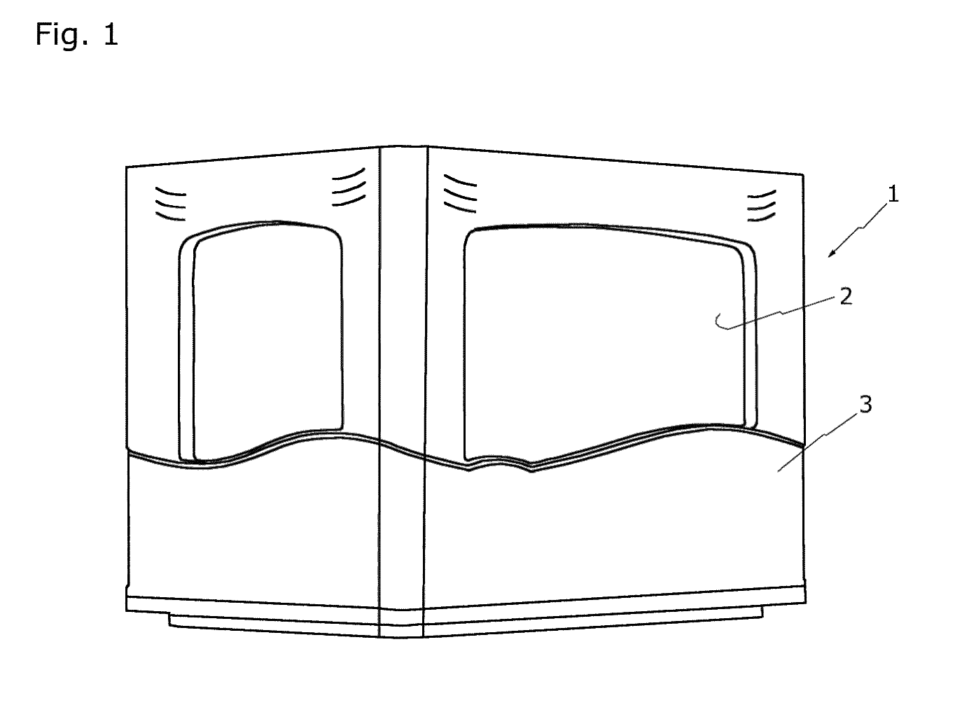

FIG. 1 a crate with a circumferential advertising medium of an IML film;

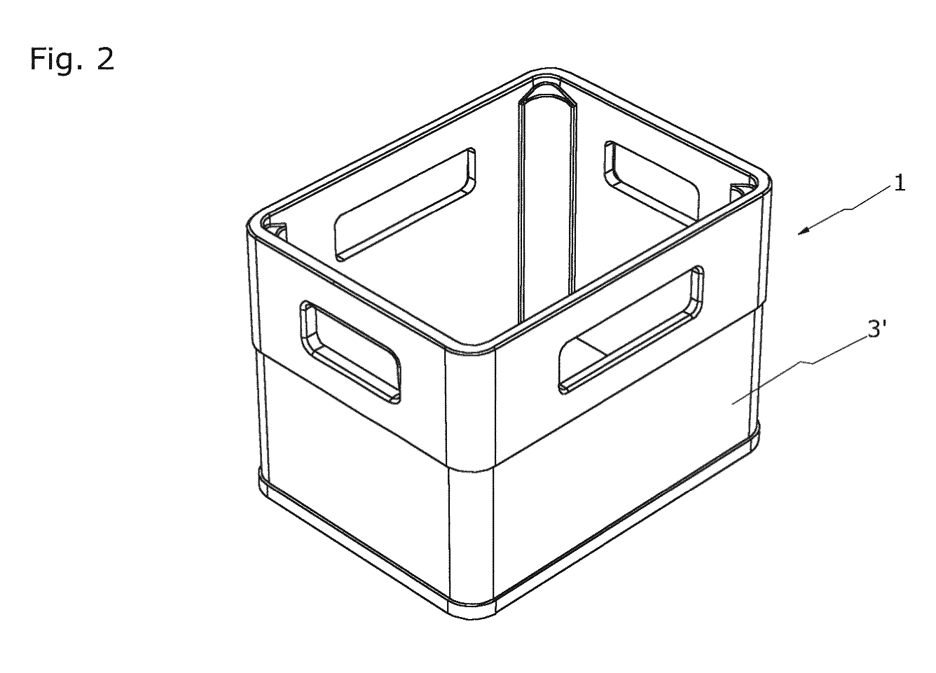

FIG. 2 a purely exemplary illustration of a bottle crate without applied label;

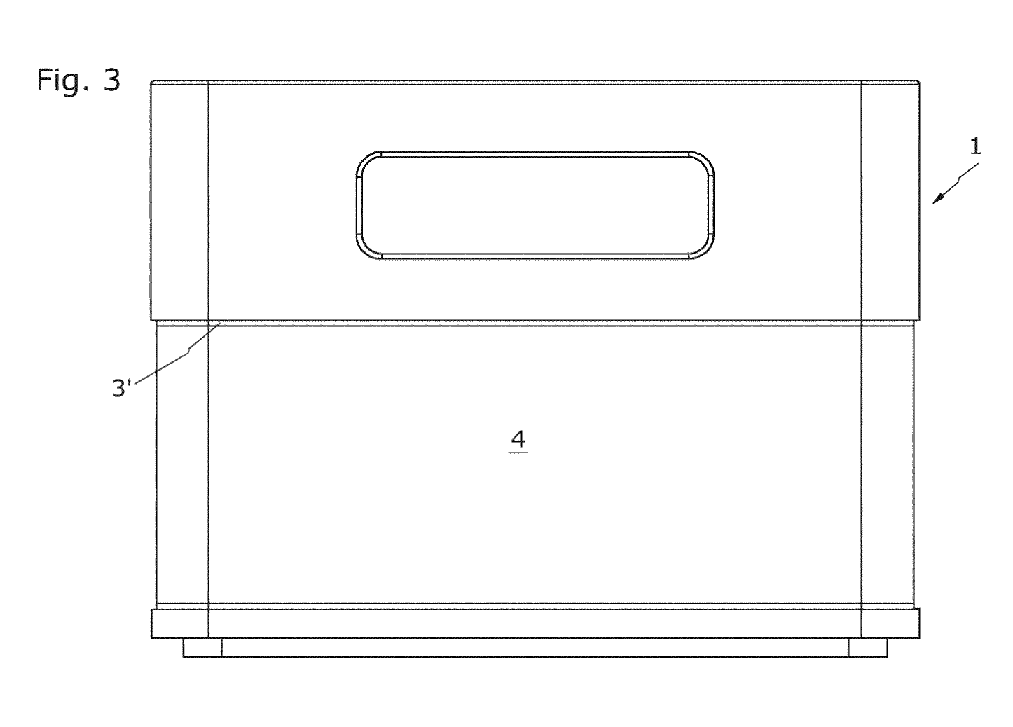

FIG. 3 a view of the side wall of the crate according to FIG. 2 but with applied label;

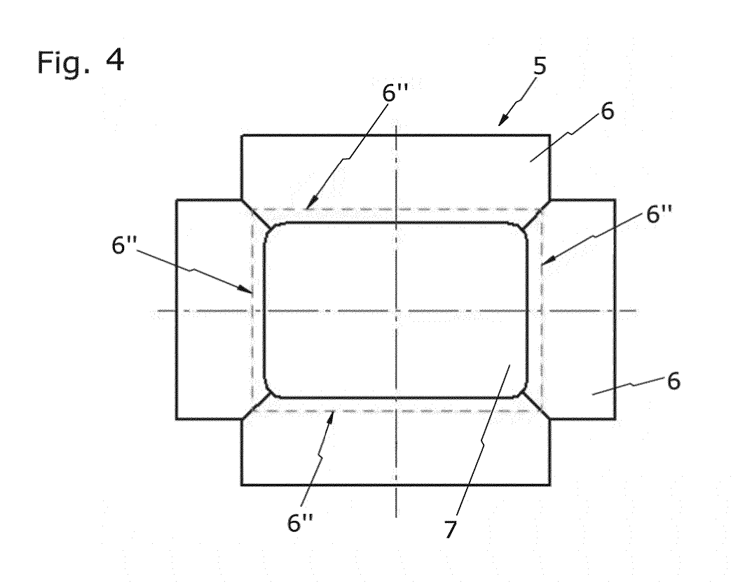

FIGS. 4 to 9 schematic representations of different positions of the injection molding;

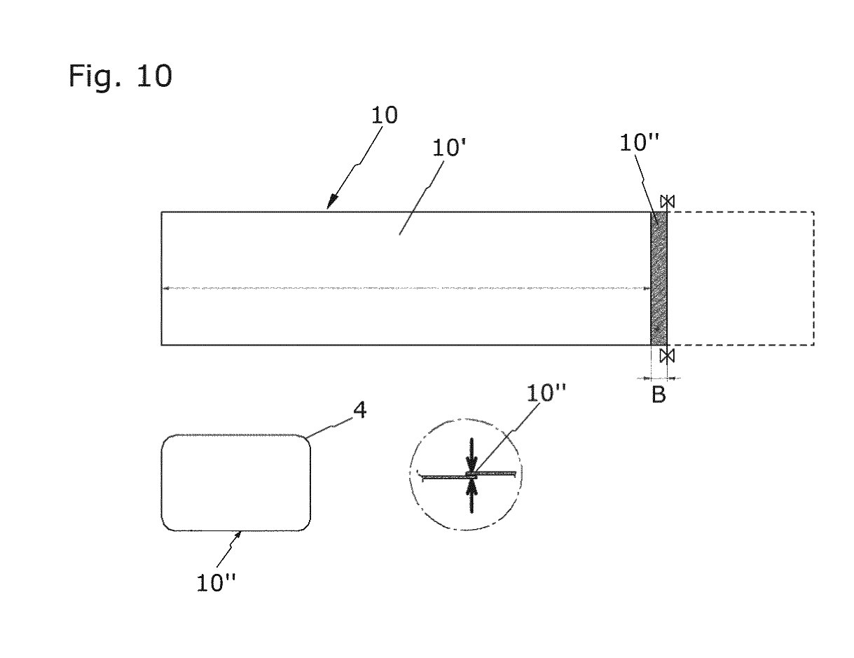

FIG. 10 a schematic representation of the length cutting of a label for the blank tube formation;

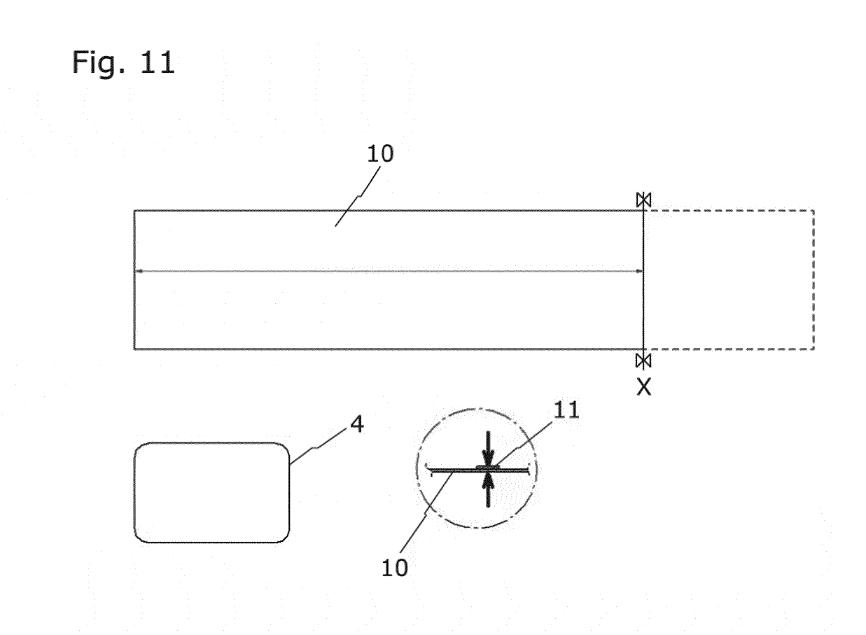

FIG. 11 an alternative embodiment to FIG. 10;

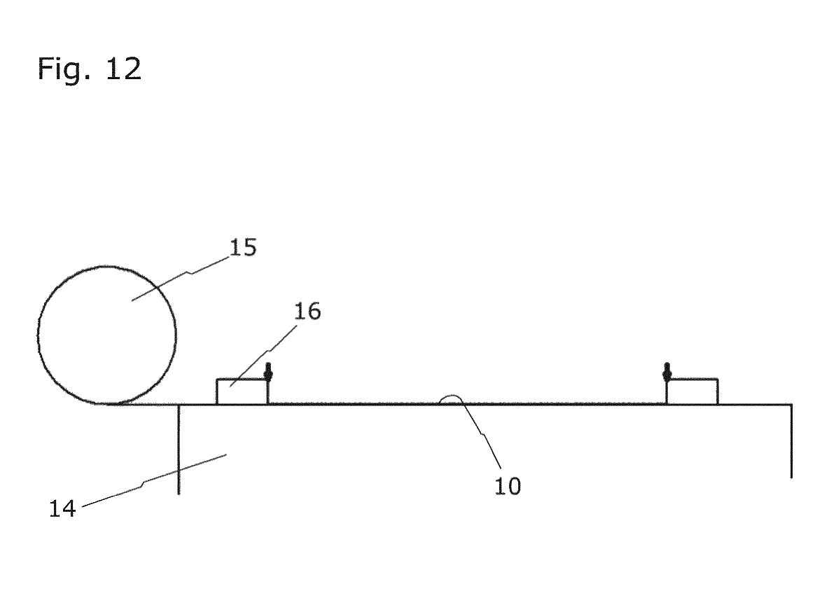

FIG. 12 a schematic representation of a receiving table for the label blank;

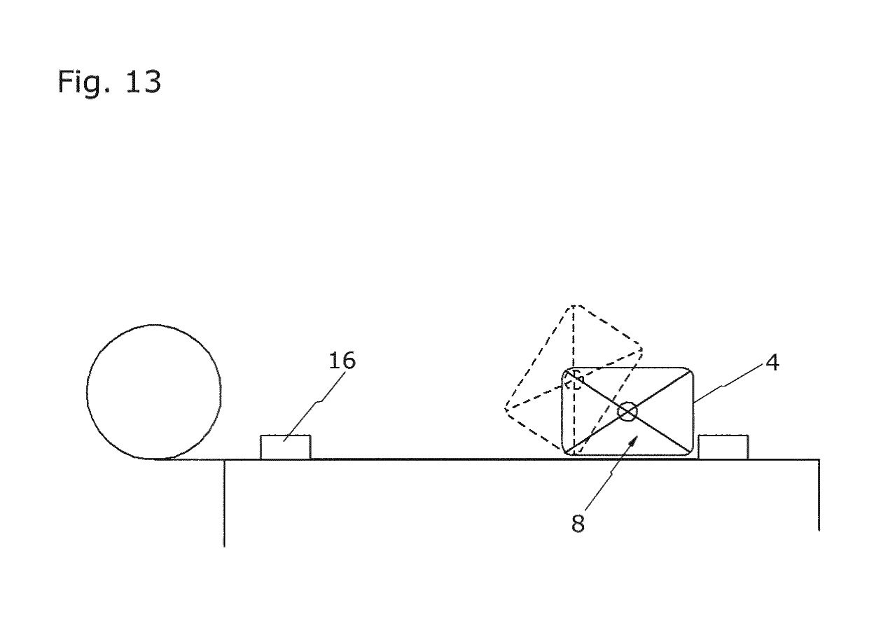

FIG. 13 a representation according to FIG. 12 but with the gripper in the functional position;

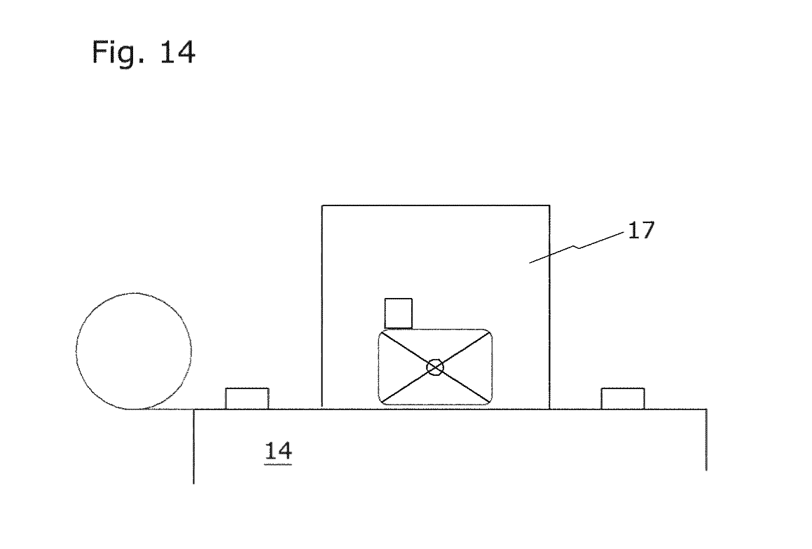

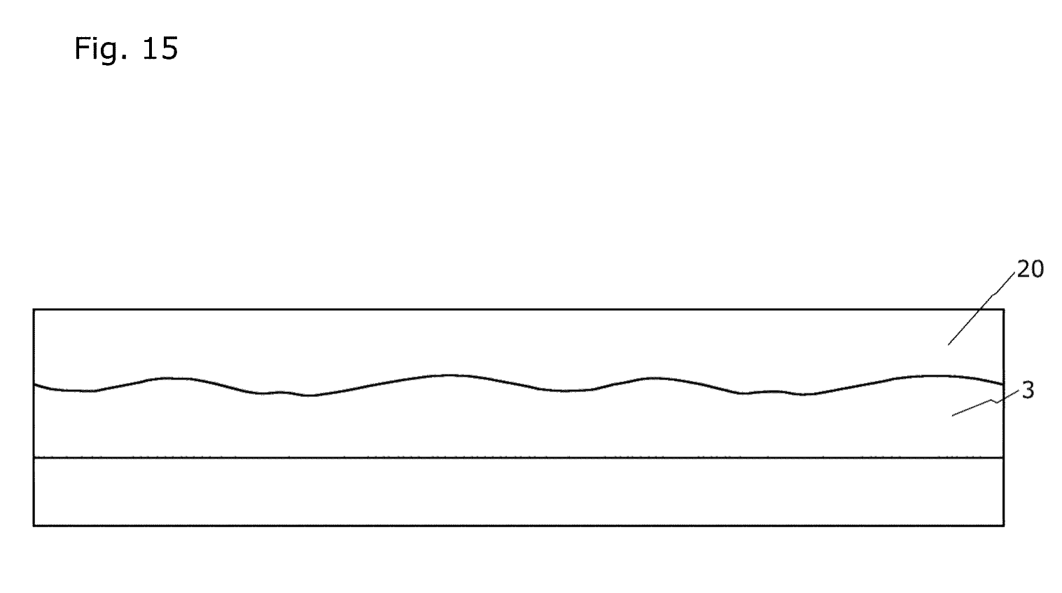

FIG. 14 an arrangement corresponding to the FIG. 13 and FIG. 15 having a joining station for forming a tube; and

FIG. 15 an endless IML film on a carrier element shown purely schematically as in all figures.

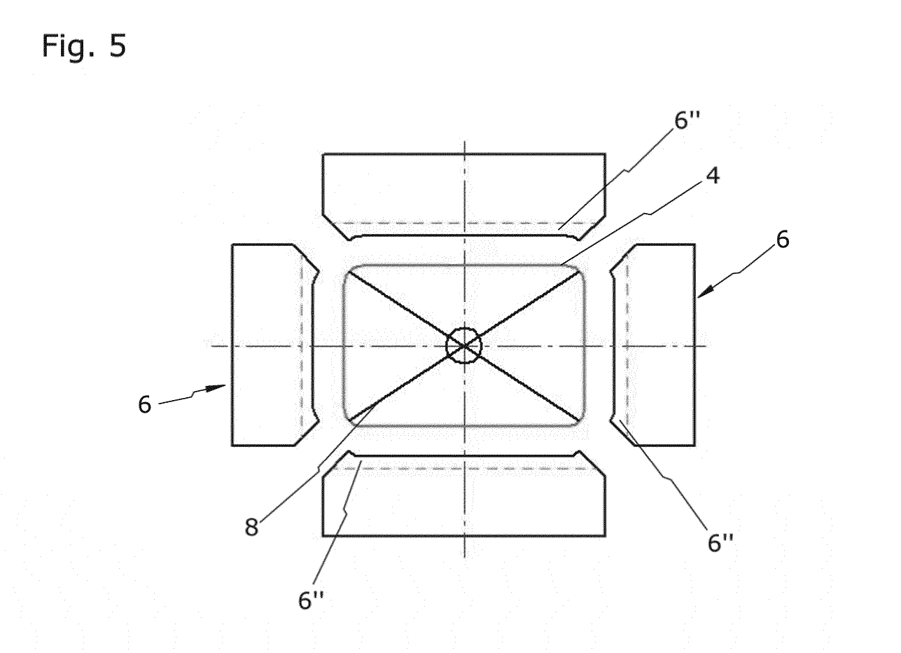

FIG. 1 shows exemplarily a bottle crate without any limitation. The crate 1 serves to receive bottles and has in the represented embodiment a substantially flat, that is rib-free outer surface except for the so-called stacking ribs usually provided which are present, for example, in the upper region of the crate. In the represented embodiment the corner portion is rounded and provided with a substantially pronounced rounding. In the usual way the bottle crate 1 is provided with display openings 2 at the side walls which is, however, absolutely not mandatory in any way, which serves, on the one hand, to form upper handle strips circumferentially around the crate, but also allows on the other hand a view of the bottles set in the crate and preferably of their label. In addition, the crate, here in the lower third, which is not limiting in any way, is provided with a circumferential label, which is preferably wave-like contoured here at the upper and lower edge of label. The label 3 as a whole is arranged around the entire circumference of the crate 1, i.e. it also extends over all four corner portions of the crate. Due to the circumferential configuration of the label in the manner of a hose 4 (FIG. 5), a gap-free application of the circumferential and preferably integral label is possible. This is very advantageous for visual reasons, so that in this way an optimal advertising nature is achievable.

FIG. 2 in turn shows by way of example another embodiment of a crate for a label arrangement, namely a circumferential label inclusion. In this case the crate 1 is provided at the top edge with four handle openings as well as with an arrangement region 3′ below the handle openings arranged for the label arrangement or inclusion. This arrangement region 3′ is disposed circumferentially about the crate, i.e. provided also in the corner regions, and is advantageously slightly set back to the inside relative to the rest of the outer surface of the crate. In this way a label received in the arrangement region is effectively protected against damage caused by scratching and the like. This measure is expedient in conjunction with the label arrangement.

FIG. 3 shows the crate represented in FIG. 2 in side view where the circumferential label hose 4 or the annular label is arranged circumferentially around the crate in the arrangement region 3′.

FIGS. 4-9 show in a purely exemplary manner a suitable tool for carrying out the process without having to specify in this way the intended tool. FIG. 4 shows the injection mold tool 5 in closed position with four circumferentially arranged tool jaws 6 that delimit a mold cavity 7 covering the outer contour of the crate to be manufactured.

FIG. 5 shows the tool according to FIG. 4 in the open position in which the tool jaws 6 are moved away to the outside and, therefore, the tool is represented in the open position.

In the represented embodiment, however by no means limiting, the tool jaws are each advantageously constructed bipartide, namely each with a molding jaw 6′ and provided with label plates 6″ received therein and shown in dashed lines in FIGS. 4 and 5 which also map on the inside the outer contour of the crate in the closed position.

According to the invention, a one-piece IML label, to be circumferentially attached at the crate, is used or provided which is introduced as IML label in form of a tube label 4 into the tool and onto the tool jaws 6 and, in particular, is transferred here advantageously to the correspondingly contoured label plates 6″. According to FIG. 5, the tool jaws 6 are in the retracted and therefore open position of the tool so that the label 3 is received via an insertion gripper 8, which is preferably circumferential on its outer contour, i.e. circumferential over the entire circumference of the crate. As part of the graphic representation, the insertion gripper 8 is represented purely exemplarily and schematically in order to simplify the description.

In any case, the IML label 3, circumferentially formed and present in the form of a tube, is introduced via the insertion gripper 8 into the open tool. As FIG. 5 shows, the tube 4 is formed and shaped here via the gripper 8 corresponding to the outer contour in the arrangement region of the later crate.

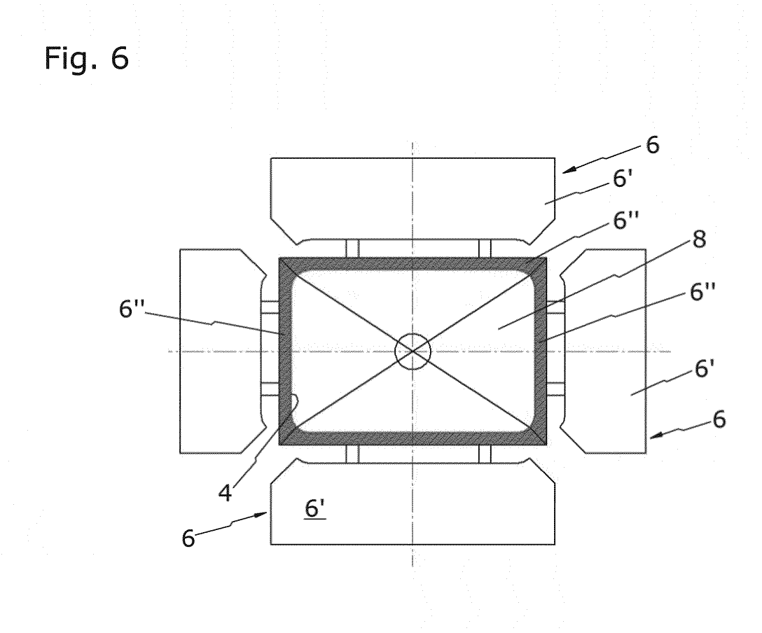

According to FIG. 6, the label plates 6″, which are in the represented embodiment exemplarily integrated into the mold jaws, are driven inwardly in contact with the label hose 4 that is received by the gripper 8. As can be seen from FIG. 6, the inner contour of the label plates 6″ is adapted to the outer contour of the circumferential label tube 4. In this position, the label plates 6″ driven inwardly are in spaced-apart position from the molding jaws 6′ of the tool jaws 6 and in abutment position or transfer position for receiving the IML tube 4.

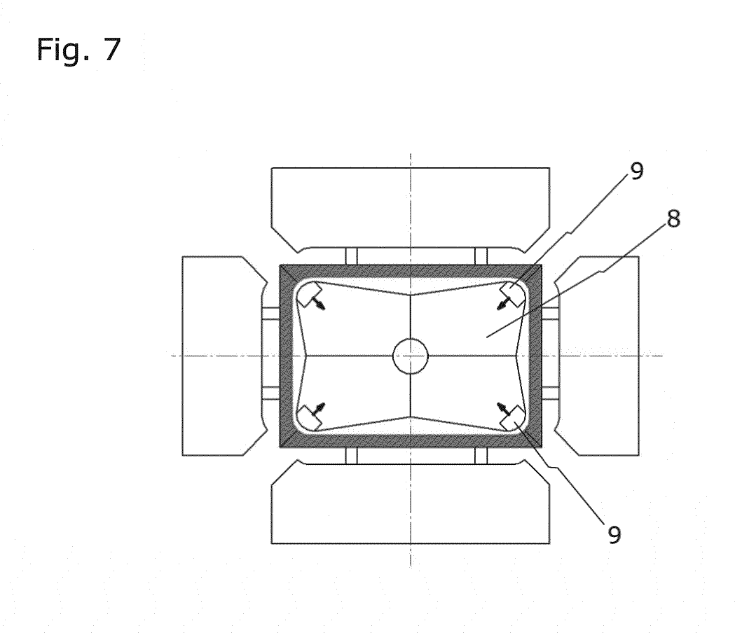

It is understood that instead of such label plates the tool jaws 6 may be moved alternatively forward in place of the label plates to directly receive the IML label 4 themselves. In any case, from FIG. 6 results that the label plates 6″ driven inwardly are close circumferentially to each other and take up the contour of the stretched hose label 4. In this position the transfer of the label tube 4 to the label plates is carried out or alternatively directly to the tool jaws 6 which can be achieved by applying a vacuum or also via a static charge or a corresponding secure bonding. In this case, the IML film may also be held as needed under applied vacuum at the gripper 8. After transfer of the IML tube 4, the gripper 8 is transferred in the removal position according to FIG. 7, so that the gripper 8 may be moved out by injection molding from the mold for the manufacture of the crate. As stated in the introduction, there are a number of suitable mechanisms for such grippers 8 in order to transfer these from a retracted position to an expanded position in which the label hose 4 is ready for handing over to the tool. In the embodiment represented according to FIG. 7, which is by no means limiting but purely given by way of example, the gripper 8 has corner jaws 9 in the four corners regions which correspondingly expand the hose contour-compliant in the extended position and make the circumference of the gripper 8 smaller in the retracted position so that a removal is possible. In the represented embodiment, the corner jaws 9 which are contour-compliant to match the corners of the crate to be manufactured, may be moved inwardly and outwardly diagonally.

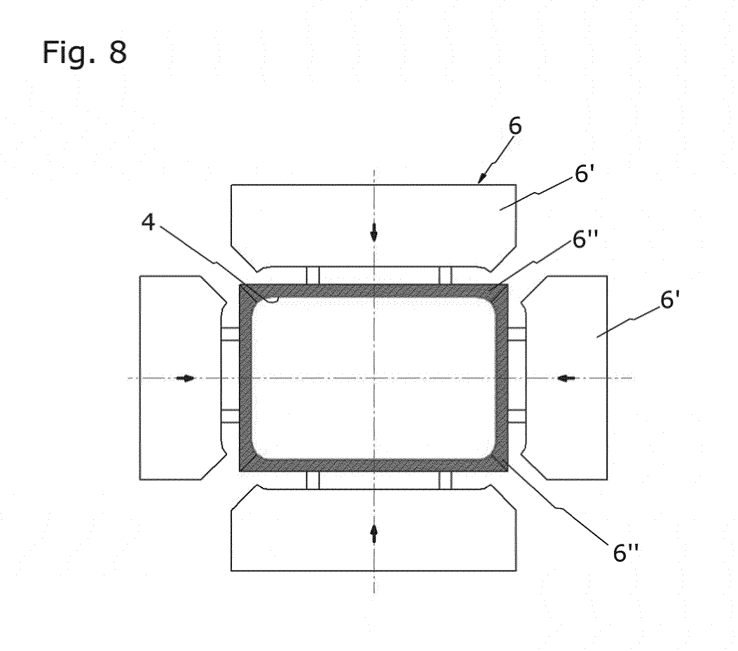

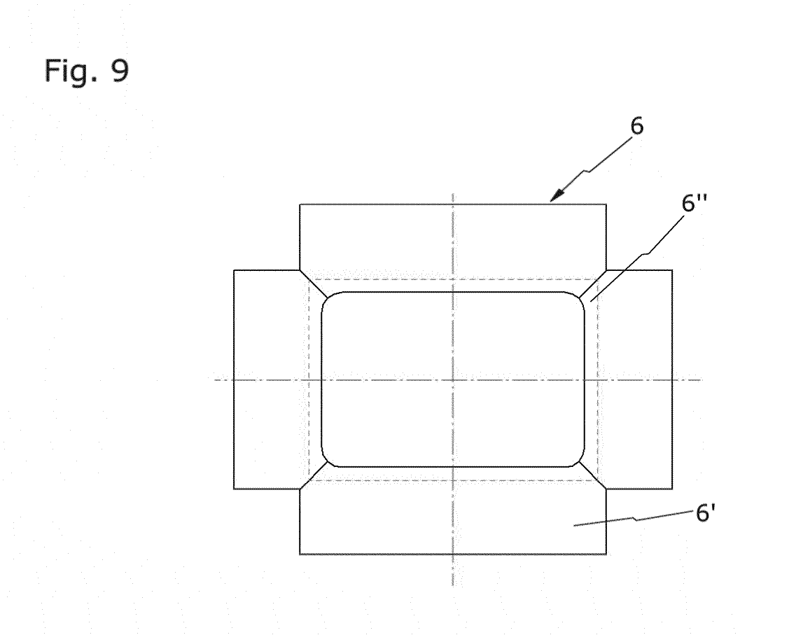

As soon as the transfer of the label tube 4 to the label plates 6″ takes place and the gripper 8 is driven out of the tool, according to FIG. 8, the molding jaws 6′ of the jaws 6 are moved inwards in the closed position, in which these label plates 6″ are including the IML film tube 4 so that the injection position is reached according to FIG. 9. In FIG. 9 the contour of the label plates 6″ is again represented by dashed lines. In this position the plastic can be injected for the manufacture of the crate after retracting a mold core for shaping the inner contour of the bottle crate, in which case the composite of the label is achieved by back injection at the crate.

Not shown are, because known per se, in case of vacuum suction the corresponding vacuum openings to which the vacuum may be applied or released to acquire the label hose 4. Such vacuum openings may be correspondingly provided at the gripper, at the tool jaws, the mold jaws and/or the label plates. However, the acquisition may also be accomplished by other appropriate means, such as secure bonding due to static charge.

In this case, it is convenient and advantageous that the IML label is precisely tailored to the length of the outer circumference of the crate so that the label ends abut after application of the label on the injection-molded crate flush joint to joint. However, advantageously the cut is done with a certain excess length to overlap the tube ends where in the overlapping area an intimate and preferably non-detachable bond is ensured and achieved, respectively, between the tube ends to form a one-piece hose.

FIG. 10 shows a label blank 10 that is made of a length portion 10′ sized and cut precisely to the periphery of the arrangement region for the label and an overlapping portion 10″. In FIG. 10 the next cut is indicated on the right in dotted lines that is, however, not yet cut off from the endless roll. The label cutting 10 is suitably wound into a ring- or tube-like structure which can be done by the gripper, where the two ends of the label blank 10 overlap because of the overlapping region 10″ as shown at the bottom right of the inscribed circle. In this overlapping area the composite of the label tube 4, shown on the left, can be achieved in an appropriate manner. Advantageously, the composite is achieved by welding or by gluing. Here, an adhesive strip activatable by pressure may be used in the overlapping area. For this purpose, it is expedient that these activatable adhesives are already provided in the overlapping sections on the endless belt of the IML roll. The overlapping region has a suitable width for a corresponding composite-compliant overlap. Practice-compliant widths are in a range of 2 to 15 mm, preferably 2 to 10 mm, preferably up to 8 mm.

In addition to FIG. 10, FIG. 11 also shows a suitable and advantageous tube formation in which case the label cutting 10 is tailored exactly to the required circumferential contour of the label arrangement which, therefore, is equal in length to the section 10′ of FIG. 10. Here, the cut takes place at the position X as is indicated in FIG. 11 accordingly. The incoming sheet of the IML roll is again indicated by dashed lines on the right.

On the bottom right there results the arrangement of a connecting strip 11 bridging a joint between the two ends of the label blank and it is preferably matched in length, which may be either outside of the tube, inside of the tube and/or, if necessary, provided on both sides. By means of this connection strip a bridging of the ends of the label blank 10 joint to joint takes place flush against each other wherein the composite, as indicated by arrows, can be achieved by welding or by gluing at this position analogous to the embodiment according to FIG. 10 so that then the label tube 4 shown on the left is formed with a circumferentially shock-free arrangement and in one-piece configuration.

Finally, FIG. 12 shows a part of the apparatus for label preparation in form of a receiving table 14 which is suitably positioned, preferably near the injection-molding die, preferably next to it. The receiving table serves preferably to cut the label film unwound from an endless roll 15 for formation of the foil cut 10, wherein the cutting apparatus 16 is shown only schematically. On the right side of the receiving table there is an apparatus for length determination so that the cutting of the label blank 10 is done to appropriately fit either to the exact length plus projection or only to the exact length depending on the embodiment of FIG. 10 or FIG. 11.

FIG. 13 shows a preferred but not limiting embodiment of a receptacle of the label blank for formation of a hose 4 by the gripper 8 which is formed to be rotatable and rolls off thereon for receiving the label blank 10 so that the hose 4 is formed on the gripper. On the receiving table 14 in FIG. 13, the cutter 16 is located again to the left and the length measuring system is on the right. The unwinding of the gripper for the contour-adapted reception of the label tube 4 is indicated by dashed representation of the gripper 8. The gripper 8 is conveniently located in flared position for receiving the label blank 10 and for its formation to become the label hose 4.

Finally, from FIG. 14 a composite station, shown only as a block diagram, is conveniently arranged on the receiving table 14 which is not limiting, however. This composite station 17 may be appropriately formed as a welding station or as an adhesive station. This is used for the connection of the label blank in the overlapping region in the embodiment according to FIG. 10 or through a connecting strip in the joint region of both ends of the label blank.

Thus, in the region of the blank station, at which the blank of the IML label is done to the exact length via an IML film wound into a roll, a length measuring system 17 is also preferably integrated at the blank station so that the correct blank 10 is ensured in terms of length, respectively. This is essential for an accurate tube formation. After cutting the tube, which is brought expediently via a centering station, not shown here, preferably in form of an expandable gripper 8 into tube formation, i.e. into an open tube, placed in a magazine from which the tube is then taken by the gripper 8 and transferred into the tool. In this case, the gripper 8 takes on the hose and prepares it, if necessary, to the outer contour in the predetermined arrangement region of the IML label in the crate to be injection-molded. The film tube 4, flared corresponding to the outer contour of the crate, is thus introduced into the interior of the open tool by the insertion gripper 8, after which the tool jaws 6 are moved into closed position and therefore in contact with this IML film. Thereby, the IML label can be received by the tool. Since, as has been described using FIG. 7, the cross-section or the periphery of the robotic insertion gripper 8 is then quasi reduced in order to be able drive it out from the tool, the tubular label 4 is received by the tool and the back injection process may then take place.

FIG. 15 shows an endless IML film 3 having wave-like contoured outer edges that is preferably wound into a roll, wherein, if necessary, the label 3 can be applied on a support member 20 in accordance with FIG. 15, for example by adhesion or a light adhesive bond such that the wound carrier or foil tape 20 which is supplied to the blank station protects the label 3 against scratching and the like. In the blank station, not shown here in the drawing for simplicity, the supplied IML film is removed from the carrier element 20 or detached and cut to appropriate length where it is possible to use a suitable length measuring apparatus 17 for purposes of control.

In the blank station, the tube formation of the cut IML label 3 is already expediently done where there are two particularly advantageous possibilities. Firstly, the blank can be exactly matched to the length of the respective outer contour of the crate with the consequence that the hose ends on the insertion gripper and ultimately also in the tool are joint to joint and thus flush and the hose composite is accomplished by a shock-covering joining strip in the manner described. Therefore, a visible gap formation is avoided and, if appropriate, in the corner of the crate as well. Expediently, however, the cutting is done with a certain excess length so that the hose ends may overlap, as is evident from FIG. 10, where the hose 4 is represented with an overlapping region 10″.

In addition to a length measuring system to control the exact length of the blank, a system may also be provided for optical length detection which may conveniently be coupled to the length measuring system or integrated therein. Conveniently, punching markers and the like are provided on the IML label that may be used accordingly. These punching markers for length detection are preferably optically readable labels which may be exemplarily and advantageously applied by printing.

Using the length measuring system, influence can be made on process-related length compensation in the process. Although not shown in the drawing, the cutting apparatus 16 or the cutting table 14 is conveniently disposed adjacent to or in the immediate vicinity of the label-positioning apparatus with the insertion gripper. In that regard, the hose 4 may be taken by the insertion gripper and placed into the open tool or, if necessary, into a magazine.

As it can be seen, the procedure is simple and can accomplish an optically perfect application of an IML advertising foil on a crate.

Moreover, it is within the scope of the invention to use a label strip already separately prepared to the exact length and therewith assembled instead of a label blank cut from a wound roll so that there is no cutting station needed.

1-17. (canceled)

18. A method of applying labels on crates with a label arrangement tool integrated into a tool for plastic injection molding of the crate that comprises a plurality of tool jaws that correspond with portions of the crate circumference, the plurality of tool jaws movable from an open position into a closed position configured to receive molten plastic, comprising:
forming label into a tube;
applying an outer surface of the tube onto the plurality of tool jaws by insertion of a gripper within the tube, the gripper having a hose that is adjusted to maintain the tube to correspond to a predetermined contour of the crate; and
closing the tool and injecting plastic into the tool to manufacture the crate.

19. The method of claim 18, wherein the tube is applied to the plurality of tool jaws with vacuum suction.

20. The method of claim 19, wherein the tube is applied to the plurality of tool jaws by bonding wherein the plurality of tool jaws are driven up to the hose at the insertion gripper when the plurality of jaws are moved to the closed position.

21. The method of claim 18, wherein the plurality of tool jaws each comprise a molding jaw and a label plate are disposed over the crate circumference, wherein the label plates are configured to be applied against the label tube positioned on the gripper.

22. The method of claim 18, wherein the length of the label corresponds at least to the length of the crate circumference.

23. The method of claim 18, wherein ends of the label are interconnected by adhesive bonding to define an overlapping region.

24. The method of claim 18, wherein ends of the label are interconnected by heat fusion

25. The method of claim 18, wherein ends of the label are interconnected with at least one connecting strip.

26. The method of claim 18, further comprising cutting the labels from a roll of wound film.

27. The method of claim 18, further according to one of the preceding claims, characterized in that the label is provided with optically readable markers.

28. The method of claim 18, further wherein the hose is formed at a blank station, and further comprising storing the hose a magazine in tubular form and using the insertion gripper to remove the hose from the magazine.

29. The method of claim 18, further comprising using docking elements on the gripper, the tool jaws, or the label plates that are brought into an engagement with the hose.

30. The method of claim 18, wherein the insertion gripper for removing the injection-molded crate from the tool can be converted into a contour with reduced circumference.

31. An apparatus for applying labels on crates, in particular bottle crates, comprising:
a cutting station in which a label blank with a length corresponding to at least to the length of the outer periphery of the crate is prepared, the cutting status having a centering station for a formation of a label tube configured to fit the crate circumference;
a label positioning station provided with an insertion gripper configured to form the label into a tube, for receiving the tube, and its transfer into the open or closed tool;
a plurality of tool jaws that correspond with portions of the crate circumference, the plurality of tool jaws movable from an open position into a closed position configured to receive molten plastic;
a gripper configured for insertion into a tube, the gripper having a hose that is adjusted to maintain the tube to correspond to a predetermined contour of the crate; and
wherein the apparatus having a closed configuration configured to receive injected plastic to manufacture the crate.

32. The apparatus of claim 31, wherein the centering station is provided as a magazine for the storage and/or receiving of the IML, labels formed each into a circumferential tube (4), which are preferably arranged next to the label positioning station formed preferably as an insertion gripper (8) in such a way that in each case a tube (4) can be removed from the magazine and can be inserted into the correct position in the tool (5).

33. The apparatus of claim 31, further comprising a length recognition system operating optically that is responsive to the detection of punch markers on the label.

34. The apparatus of claim 31, further comprising a length measuring system for checking the length of the label for the hose formation in adaptation to the total circumference of the crate.

35. The apparatus of claim 31, further comprising a docking-elements for tube positioning.

36. The apparatus of claim 31, wherein the insertion gripper is provided with movable construction elements that represents the outer contour of the crate in an arrangement region of the label in an extended position and in a retracted position corresponding to a contour of the insertion gripper.

37. A crate, comprising
four circumferential side walls and a bottom which is formed of plastic by injection molding,
a single label positioned over the a crate circumference such that the label is formed as an encircling hose.
